(19) United States
(12) Patent Application Publication
(10) Pub. No.: US 2026/0230989 A1
(43) Pub. Date: Aug. 6, 2026

(54) NES-RELATED CONDITIONAL HANDOVER

(71) Applicant: Telefonaktiebolaget LM Ericsson (PUBL), Stockholm (SE)

(72) Inventors: Helka-Liina MÄÄTÄNEN, Jorvas (FI); ALI NADER, Lund (SE); SINA MALEKI, MALMÖ (SE)

(21) Appl. No.: 19/151,666

(22) PCT Filed: Feb. 15, 2024
(86) PCT No.: PCT/EP2024/053878

§ 371 Date: Jul. 29, 2025

Related U.S. Application Data
(60) Provisional application No. 63/485,315, filed on Feb. 16, 2023.

(51) Int. Cl. H04W 36/36; H04W 52/02

(52) U.S. Cl. CPC H04W 36/362; H04W 52/0203

(57) ABSTRACT

The present disclosure relates to a method performed by a User Equipment, UE, for Network Energy Saving, NES,-related Conditional Handover, CHO, in mobile communications. The method comprises obtaining NES information for a conditional handover process, wherein the NES information indicates a candidate target cell for the conditional handover process. The present disclosure also relates to a method performed by a network node for Network Energy Saving, NES,-related conditional handover in mobile communications. The method comprises providing NES information for a conditional handover process to a User Equipment, UE, wherein the NES information indicates a candidate target cell for the conditional handover process. There is also provided a UE and a network node.

### TECHNICAL FIELD

Embodiments of the present disclosure are directed to methods in a User Equipment, UE, and methods in a network node of a communications network. Further embodiments are directed to a UE and a network node respectively.

### BACKGROUND

### NW Energy Consumption

Energy consumption is a considerable challenge for fifth generation (5G) systems today where a major contributor to the energy consumption is the radio unit of the radio access network (RAN) system. The network power consumption for New Radio (NR) is said to be less compared to Long Term Evolution (LTE) because of its lean design, i.e., no cell-specific reference signal (CRS) and the synchronization signal block (SSB) periodicity is by default 20 ms. However, NR in the current implementation might consume more energy compared to LTE, partly due to higher bandwidths, shorter transmission time interval (TTIs) and a large number of antennas. This is still evident even at times when cells and beams are lightly loaded or serve no traffic or no users at all. To enable an energy efficient network, Third Generation Partnership Project (3GPP) initiated a study item (SI) on network energy savings in NR, which was concluded with the outcome captured in TR 38.864 (TR 38.864, Study on network energy savings for NR (Release 18) version i00).

Following the SI phase, a new work item (WI) on network energy savings for NR was approved. The WI aims to specify the following enhancements:
1. Specify SSB-less SCell operation for inter-band CA for frequency range 1 (FR1) and co-located cells, if found feasible by RAN4 study, where a UE measures SSB transmitted on primary cell (PCell) or another secondary cell (SCell) for an SCell's time/frequency synchronization (including downlink automatic gain control (AGC)), and layer 1/layer 3 (L1/L3) measurements, including potential enhancement on SCell activation procedures if necessary.
2. Specify enhancement on cell discontinuous transmission/discontinuous reception (DTX/DRX) mechanism including the alignment of cell DTX/DRX and user equipment (UE) DRX in RRC_CONNECTED mode, and inter-node information exchange on cell DTX/DRX.
   Note: No change for SSB transmission due to cell DTX/DRX.
   Note: The impact to IDLE/INACTIVE UEs due to the above enhancement should be avoided.
3. Specify the following techniques in spatial and power domains:
   Specify necessary enhancements on CSI (Channel State Information) and beam management related procedures including measurement and report, and signaling to enable efficient adaptation of spatial elements (e.g. antenna ports, active transceiver chains).
   Specify necessary enhancements on CSI related procedures including measurement and report, and signaling to enable efficient adaptation of power offset values between PDSCH (Physical Downlink Shared Channel) and CSI-RS.
   Note: Above objectives are only for UE specific channels/signals.
   Note: Legacy UE channel state information (CSI)/CSI reference signal (CSI-RS) capabilities applies when considering total number of CSI reports and requirements.
4. Specify mechanism(s) to prevent legacy UEs camping on cells adopting the Rel-18 Network Energy Saving (NES) techniques, if necessary.
5. Specify conditional handover (CHO) procedure enhancement(s) when source/target cell is in NES mode.
6. Specify inter-node beam activation and enhancements on restricting paging in a limited area.
7. Specify the corresponding radio resource management/radio frequency (RRM/RF) core requirements, if necessary, for the above features.

### Conditional Handover (CHO)

When the radio link becomes degraded and the UE needs to send measurement reports, it is possible that those reports never reach the network because the uplink link is degraded or even if those reports reach the network, the network tries to respond with a handover command that may never reach the UE. This may be due to the downlink being degraded or the handover command is so large that multiple transmissions are required. In a non-terrestrial network (NTN), even if the UE may know how long a satellite may serve before the service link switch, e.g. with the help of ephemeris data, channel conditions such as certain terrain, may still yield limited accessibility, e.g., UE is shadowed by a mountain. FIG. 1 shows when these two cases might happen.

To remedy these failure cases, conditional handover (CHO) was introduced. The main motivation of the conditional handover procedure is to reduce the number of failure occurrences while a UE is moving, e.g., when a handover between cells fails or when a connection fails even before a handover (HO) is triggered.

In conditional handover, instead of preparing one target cell as in a regular (non-CHO) handover, one or more candidate target cells are prepared in advance in the network. This enables the network to send the handover command to the UE at an earlier stage compared to a regular handover, i.e., the handover command is sent when the radio conditions for the UE and/or the cells are still good, rather than when the radio conditions start to get degraded as in a regular handover. When received, the UE stores the handover command (and the RRC configurations included in the message), instead of applying it immediately, and starts to evaluate the CHO trigger condition(s) configured by the network. The UE only applies the stored handover command (and the associated RRC configuration) when the CHO trigger condition(s) configured by the network is satisfied for one of the configured candidate target cells. Then the UE executes the handover and connects to the target node as in a regular handover.

In conditional handover, instead of transmitting the measurement report, the UE applies the stored handover command message (and the associated Radio Resource Control, RRC, configuration) when the CHO trigger condition is satisfied for one of the configured candidate target cells. The network may also configure two CHO trigger conditions for the UE and associate both to the stored handover command, i.e., the handover command is applied only if both CHO trigger conditions are fulfilled, e.g., conditions configured for different types of measurement quantities, such as cell coverage represented by reference signal received power (RSRP), and quality represented by reference signal received quality (RSRQ).

It is also possible that a failure is detected while the UE is monitoring the configured conditions. In the legacy approach, the UE would perform the cell selection and continue with a re-establishment procedure. However, with conditional handover, when the same type of failure is detected, e.g., a radio link failure or handover failure, the UE may prioritize a cell for which it has a stored handover command and, instead of performing re-establishment, the UE performs a conditional handover, which reduces the interruption time and the signalling over the air interface.

### Rel-17 3GPP for CHO in NTN

In Rel-17, the CHO was enhanced in the context of non-terrestrial network (NTN) WI. The following new conditions were introduced:
A measurement-based trigger condition called A4; “Neighbor becomes better than threshold”.
A time-based trigger condition; based on a time window which indicates when the UE may trigger and execute CHO to a candidate target cell.
A location-based trigger condition; based on a distance threshold from the UE to the source cell and to a candidate target cell, i.e., distance between the device and the serving cell reference location, referenceLocation1, becomes larger than absolute threshold1 and the distance between device, and the candidate target cell reference location, referenceLocation2, becomes shorter than absolute threshold2.

Furthermore, in Rel-17, the NR NTN device may be configured with maximum two trigger conditions per candidate target cell. The time and location-based trigger conditions are only supported in combination with a measurement-based trigger condition. It is not possible to configure time and location-based trigger conditions simultaneously.

The location-based condition for CHO follows the RRM event of D1. The time-based event is defined by T1 and a duration. The event itself becomes fulfilled when time measured at UE becomes more than configured threshold T1 but is less than T2 where T2 is T1+duration. As time-based event is configured together with signal quality/strength event, the CHO may be performed to a candidate target cell when the signal strength related event is fulfilled during the time between T1 and T2.

### SUMMARY

There currently exist certain challenge(s). For example, currently the only mechanism to account NES cell or NES mode for a cell for mobility is to tune the existing CondEvent thresholds by the source cell. Further, if the source cell does not know the NES mode or NES type of the candidate target cell, it is not possible to account the NES cell or NES mode for that cell for mobility or handover. In another example, it is not possible to prioritize the candidate target cells which have fulfilled the configured thresholds.

Certain aspects of the disclosure may provide solutions to these or other challenges. For example, particular embodiments provide NES information and/or or other mobility related signaling in CHO configuration to the UE.

In another example, particular embodiments provide various implementations for the NES information and UE actions based on the type of NES information or how the NES information is provided.

Certain embodiments may provide one or more of the following technical advantage(s). For example, particular embodiments enable UE mobility which accounts the NES type or mode of source or candidate target cells.

The present invention is defined in the independent claims, to which reference is now directed.

There is provided a method performed by a User Equipment, UE, for Network Energy Saving, NES,—related Conditional Handover, CHO, in mobile communications. The method comprises obtaining NES information for a conditional handover process. The NES information indicates a candidate target cell for the conditional handover process.

The NES information may include at least one of: an offset in a Reference Signal Received Power, RSRP, an offset in a Reference Signal Received Quality, RSRQ, a duration and a location.

In some embodiments, a conditional event for the conditional handover process may be configured, the conditional event having a threshold related to a NES mode of a source cell. In these embodiments, the method may further comprise evaluating the conditional event for the conditional handover process based on the threshold.

In some embodiments, the method may further comprise receiving an indication that the UE may be handed over from a source cell to the candidate target cell according to the conditional handover process. The method may further comprise triggering the conditional handover process in response to the indication. The indication may thus be a condition for handover according to the conditional handover process.

The indication may be received from the source cell.

In particular, the indication may be received in a bitfield in a Downlink Control Information (DCI).

The NES information may be received from a source cell.

In some embodiments, the NES information may be received in a Radio Resource Control (RRC) configuration message associated with the candidate target cell.

For example, the NES information may be received in a CHO configuration for the conditional handover process.

In particular, the NES information may be included within IE CondTriggerConfig-r16.

The NES information may indicate that a cell is a NES cell, i.e. a cell that may be in NES mode.

There is further provided a method performed by a network node for Network Energy Saving, NES,—related conditional handover in mobile communications. The method comprises providing NES information for a conditional handover process to a User Equipment, UE. The NES information indicates a candidate target cell for the conditional handover process.

The NES information may include at least one of: an offset in a Reference Signal Received Power, RSRP, an offset in a Reference Signal Received Quality, RSRQ, a duration and a location.

The method may comprise configuring a conditional event for the conditional handover process, the conditional event having a threshold related to a NES mode of a source cell.

The method may further comprise sending an indication, to the UE, the indication indicating that the UE may be handed over from a source cell to the candidate target cell according to the conditional handover process. The indication may thus be a condition for handover according to the conditional handover process.

In particular, the indication may be provided in a bitfield in a Downlink Control Information (DCI).

In some embodiments, the NES information may be transmitted to the UE in a Radio Resource Control (RRC) configuration message associated with the candidate target cell.

The NES information may be included in a CHO configuration for the conditional handover process.

For example, the NES information may be provided within IE CondTriggerConfig-r16.

The NES information may indicate that a cell is a NES cell.

There is also provided a User Equipment, UE, configured for network energy saving, NES-related conditional handover in mobile communications. The UE comprises processing circuitry configured to perform any of the methods described above as performed by a UE. The UE further comprises power supply circuitry configured to supply power to the processing circuitry.

There is also provided a network node configured for network energy saving, NES, related conditional handover in mobile communications. The network node comprises processing circuitry configured to perform any of the methods described above as performed by a network node. The network node further comprises power supply circuitry configured to supply power to the processing circuitry.

### BRIEF DESCRIPTION OF THE DRAWINGS

Some embodiments will now be described more fully with reference to the accompanying drawings. Embodiments are provided by way of example to convey the scope of the subject matter to those skilled in the art.

FIG. 1 illustrates example mobility related failure scenarios;

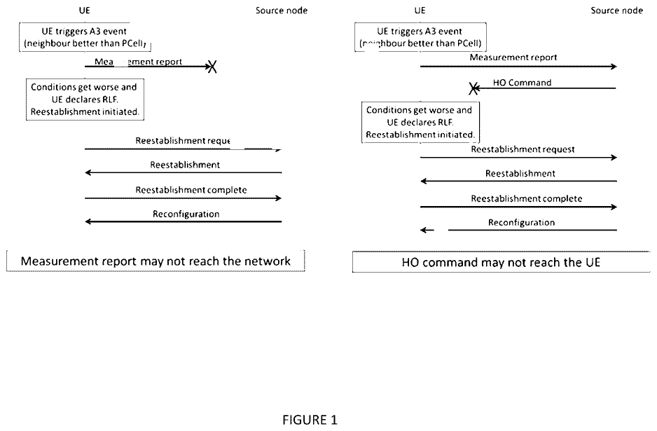

FIG. 2 illustrates an example of a communications system in accordance with some embodiments;

FIG. 3 shows a UE in accordance with some embodiments;

FIG. 4 shows a network node in accordance with some embodiments;

FIG. 5 is a block diagram illustrating a virtualization environment in which functions implemented by some embodiments may be virtualized;

FIG. 6 is a flow chart showing a method in a UE according to an embodiment; and

FIG. 7 is a flow chart showing a method in a network node according to an embodiment.

### DETAILED DESCRIPTION

Note: Unless otherwise stated explicitly the methods proposed herein concern both fixed and moving cells, service and feeder link switches.

Note: Unless otherwise stated explicitly, the terms cell and beam are used interchangeably in this disclosure.

Note: The terms “wireless terminal”, “User Equipment”, “UE”, “wireless device” and “device” are used interchangeably in this document.

Note: The terms “CHO event” and “CHO trigger condition” are used interchangeably in this disclosure. Similarly, the terms “event” and “trigger condition” and “condition” in the context of CHO are used interchangeably in this disclosure. These teams are equivalent to the terms “CHO event” and “CHO trigger condition”. These terms may be used in the context of measurement reporting.

In some embodiments, NES information may be provided in CHO command to the UE within IE CondTriggerConfig-r16 or CondReconfigToAddMod-r16 which means that the information about a candidate target cell is provided by the source cell. This means that source cell has obtained the information from the candidate target cell, or decided the NES information, or the NES information is provided by an external network node handling the conditional handover coordination.

In some embodiments, the NES information may be provided within the field condRRCReconfig-r16, which contains the RRCReconfiguration message of the candidate target cell. Thus, in some embodiments, the candidate target may place the NES information during the CHO preparation phase. This message may include both UE dedicated part of the RRCReconfiguration as well as any system information provided in the message.

In some embodiments, e.g., including the embodiments described above, the UE may use the NES information for one or more of the following:

In some options, UE may use the NES information in scaling a threshold of a configured condEvent (e.g.,. conditional event). For example, the said NES information may be or include one or more of an offset in RSRP, an offset in RSRQ, T1, a duration, a location. In the same or other examples, the NES information may be defined or include other parameters and/or ways on how the NES information may scale a threshold. For example, if NES information informs the UE that cell is a NES cell (e.g., a cell that may be in NES mode), there may be a predefined scaling to be applied. In the same or another example, if in addition to informing that target cell is a NES cell, UE is informed that a NES cell is in NES mode at the time of evaluating the condition for CHO, another scaling may be applied.

In some options, UE may use the NES information in ranking the candidate target cells for which the configured event has been fulfilled. Based on the ranking, UE decides which cell to enter. Note that this is for the case where more than one candidate target cell as fulfilled the configured condEvent(s).

In some embodiments, a new conEvent may be defined which has directly a threshold related to NES mode of either a source cell or candidate target cell(s). For example, the condEvent may be defined as hard limit that UE is not able to consider a NES cell, or a NES cell in NES mode if the source cell is not in NES mode. This would be advantageous if network does not want to handover UEs to other NES cells/NES cells in NES mode as long as the current serving cell is able to properly serve the Ues, or vice versa. In some embodiments, a NES cell or a NES cell in NES mode may be prioritized in CHO. This may be because it is the NES Ues which may be able to properly serve by a NES cell which may be in NES mode. Which way is preferred may depend on network deployment and amount of NES capable Ues in the network.

In some embodiments, the NES information may be provided from the target cell during the handover procedure instead of or in addition to system information. For example, the Random Access procedure of CHO towards the target may be extended to carry said NES information.

In some embodiments, there may be a separation between what the gNB supports (might use during NES mode) and what the gNB is currently using. For example, the gNB may indicate that it supports Cell DTX/DRX, but not currently be in Cell DTX/DRX. In some embodiments, the UE may be provided information from a serving cell about a target cell in a partial way such that only the supporting NES feature of target cell is provided through the serving cell. Instead, to acquire the full information including the current NES technique currently used may be derived from the target cell itself via system information or via information exchange between the target cell and the UE during the CHO procedure.

In some embodiments, the NES mode for a target cell may be provided from the source cell. As such, in some embodiments, the UE would already have partial/full (see explanation above) information about various target cells' NES mode.

In some embodiments, one or more of the NES techniques that are to be used by the target cell may be associated with a time schedule. For example, the target cell may advertise in system information that the gNB is going to turn off its radio at a certain time expressed by e.g., frame number (for example system frame number), or actual universal time coordinated (UTC) time, or the like. The information may be short-and/or long-scale, e.g. the information may cover one or more seconds from the current time and/or may provide information about daily/weekly type of schedule.

In some embodiments, the NES mode and associated information (e.g., support, time schedule, etc.) mentioned above may be more granular than that of cell level. For example, the information may instead be provided per part of the cell such as per beam (e.g., per SSB).

In some embodiments, if the UE buffer status report (BSR) is higher than a first threshold, the UE may handover from a first source cell to a second target cell. This is particularly advantages, e.g., if as a result of antenna adaptation or other NES techniques, the UE UL throughput has been reduced, and thus if there is e.g., a sudden rush of UL data, the UE may move to another cell so its UL capacity increases. Alternatively, if the UE BSR is lower than a second threshold, then the UE may handover from a first cell to a second cell. This is particularly advantageous, e.g., if the UE buffer is empty or has less than a threshold number of data packets, and thus a cell may operate in a more energy saving NES mode than the current cell supports or has configured, and thus the UE may move to a target cell that is configured with that NES mode, e.g., with a lower number of antennas. Some embodiments, including the embodiments described above may be readily extended to the case where the UE BSR is replaced by other traffic measurements key performance indicators (KPIs), e.g., expected volume of data, latency, service level agreements, service/UE type, etc. For example, if the UE is or has reduced capability (RedCap), it should handover from a first cell to a second cell where RedCap Ues are served.

In some embodiments, a UE may handover from a first cell to a second cell, if one or more specific NES modes are turned off in that cell, e.g., antennas are not reduced, power is not adapted, cell DTX/DRX is turned off or deactivated or de-configured, SSBs are transmitted over Scells, on-demand SSB/SIB1 is not configured or deactivated, etc. As such, in some embodiments, the UE may receive an implicit or explicit indication that a specific NES mode or technique is not applied, or its impact is reduced and thus has to handover. For example, if the number of antenna ports or elements is more than a first threshold, the UE may handover to a second cell possibly with lower number of antenna ports and elements.

In some embodiments, an indication is used as a condition for handover, e.g., a bitfield in a System Information Block, SIB, a Downlink Control Information, DCI, or a Medium Access Control-Control Element, MAC-CE, can indicate to the UE that it may or should HO from a first cell to a second cell, particularly if the information is from the source cell. Alternatively, or in addition, the indication may be received from the second cell or the target cell, e.g., a bitfield in SIB, DCI or MAC-CE indicating if the second cell accepts the HO of the UE, or if that the UE can or should HO to the target cell.

In some embodiments, the condition for HO may be a specific pattern in Reference Signal, RS, e.g., a specific SSB, CSI-RS, tracking reference signal (TRS), etc.

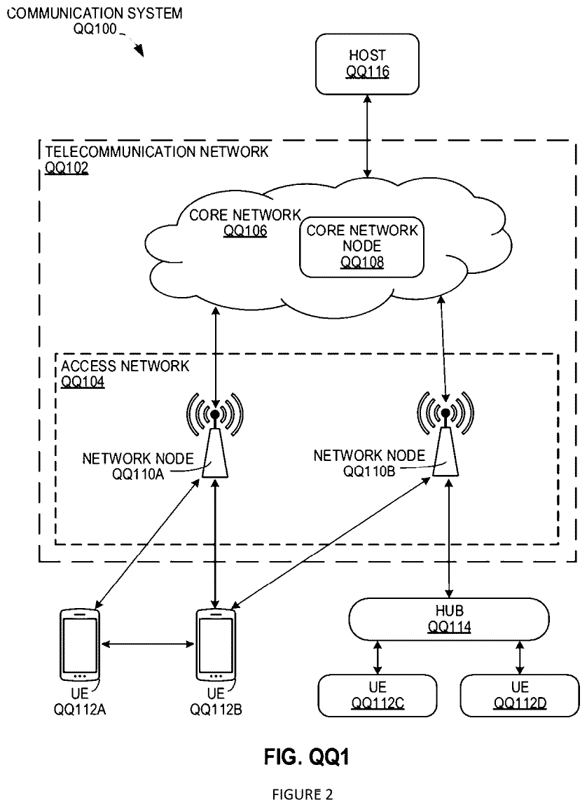

FIG. 2 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. QQ1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

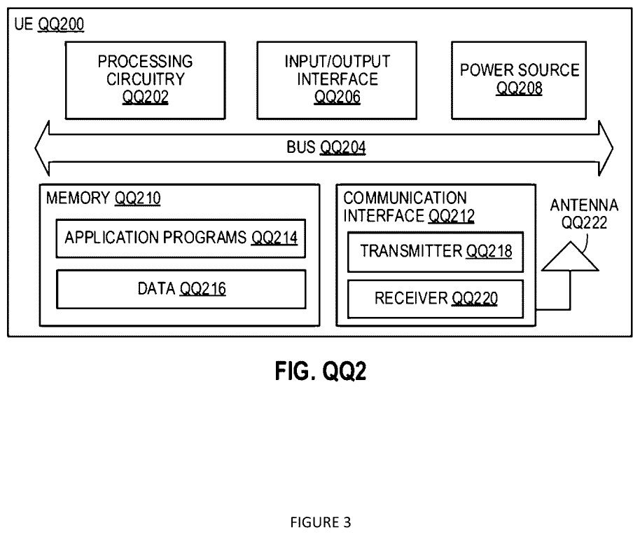

FIG. 3 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

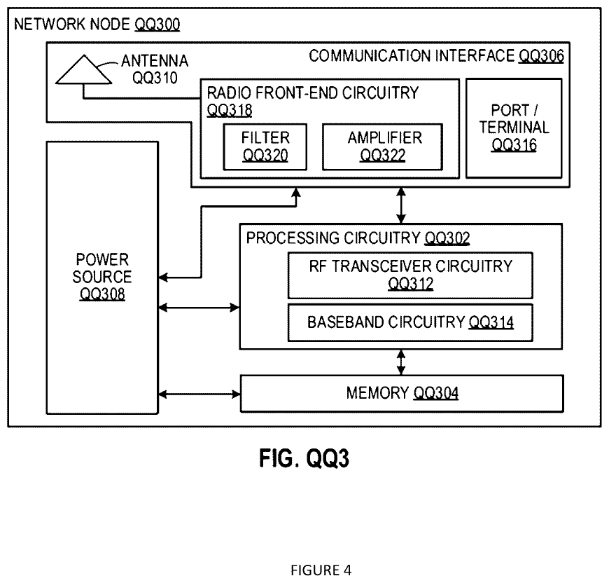

FIG. 4 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

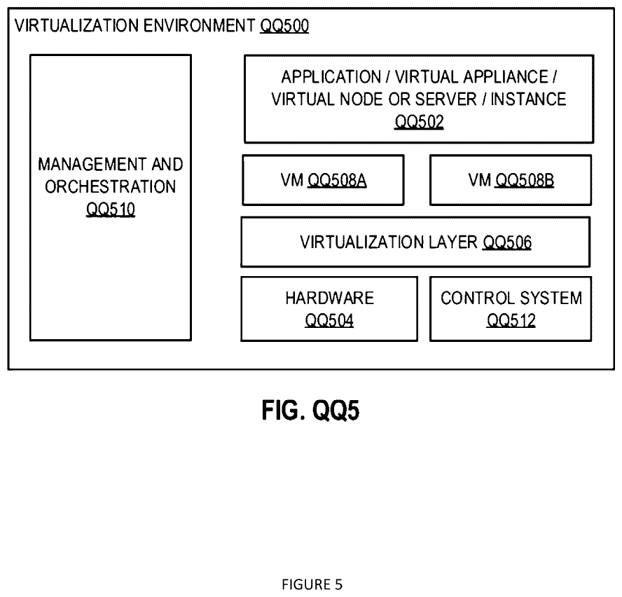

Embodiments of the network node QQ300 may include additional components beyond those shown in FIG. QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300. FIG. 5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

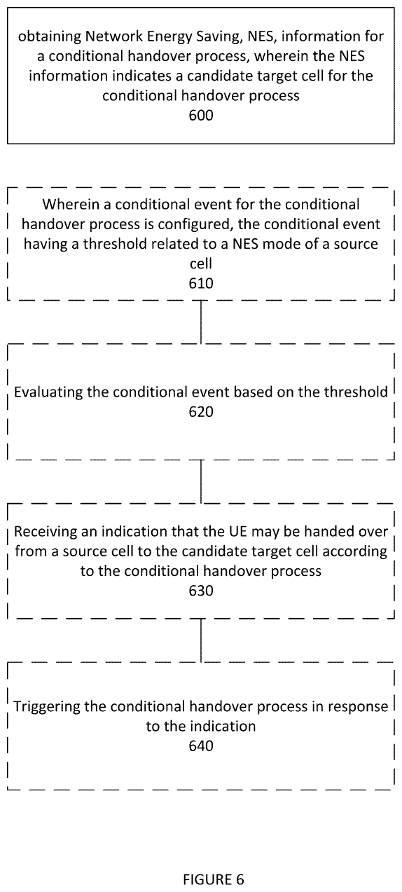

FIG. 6 is a flowchart illustrating an example method in a User Equipment, UE, according to certain embodiments. The method is for NES-related Conditional Handover, CHO, in mobile communications. In particular embodiments, one or more steps of FIG. 6 may be performed by UE 200 described with respect to FIG. 3.

The method may comprise, at step 600, the UE (e.g., UE 200) obtaining, for example receiving, NES information for a conditional handover process. The NES information indicates a candidate target cell for the conditional handover process.

The NES information may include at least one of: an offset in a Reference Signal Received Power, RSRP, an offset in a Reference Signal Received Quality, RSRQ, a duration and a location.

As shown at step 610, in some embodiments, optionally, a conditional event for the conditional handover process may be configured, the conditional event having a threshold related to a NES mode of a source cell.

At step 620, the method may further comprise evaluating the conditional event for the conditional handover process based on the threshold.

Further, in some embodiments, at step 630, the method may optionally further comprise receiving an indication that the UE may be handed over from a source cell to the candidate target cell according to the conditional handover process.

At step 640, the method may further comprise triggering the conditional handover process in response to the indication. The indication may thus be a condition for handover according to the conditional handover process.

The indication may be received from the source cell.

Advantageously, the indication may be received in a bitfield in a Downlink Control Information (DCI).

The NES information may be received from a source cell.

For example, in some embodiments, the NES information may be received in a Radio Resource Control (RRC) configuration message associated with the candidate target cell. For example, the NES information may be received in a CHO configuration for the conditional handover process. In particular, the NES information may be included within IE CondTriggerConfig-r16.

The NES information may indicate that a cell is a NES cell, i.e. a cell that may be in NES mode.

Modifications, additions, or omissions may be made to the method of FIG. 6. Additionally, one or more steps in the method of FIG. 6 may be performed in parallel or in any suitable order.

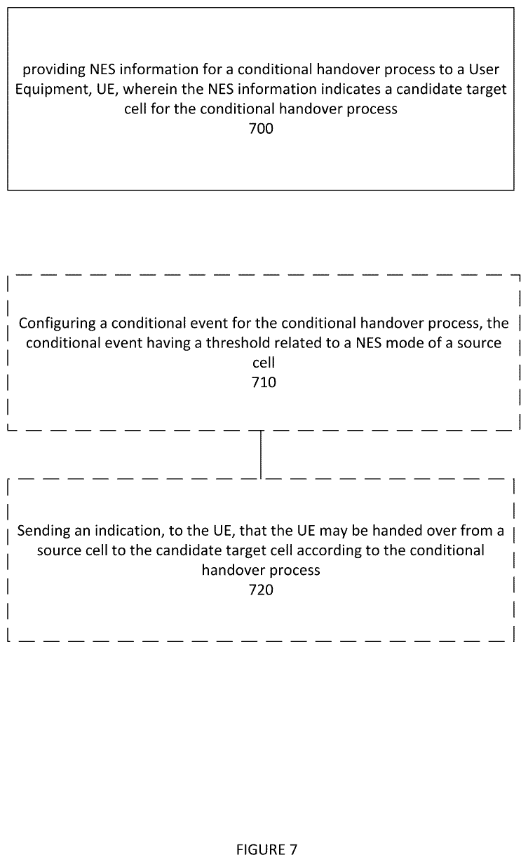

FIG. 7 is a flowchart illustrating an example method in a network node, according to certain embodiments. The method may be for Network Energy Saving, NES,-related conditional handover in mobile communications. In particular embodiments, one or more steps of FIG. 7 may be performed by network node 300 described with respect to FIG. 4. The network node may be a network node of a source cell.

The method may comprise, at step 700, the network node (e.g., network node 300) providing, for example sending, NES information for a conditional handover process to a User Equipment, UE. The NES information indicates a candidate target cell for the conditional handover process.

The NES information may include at least one of: an offset in a Reference Signal Received Power, RSRP, an offset in a Reference Signal Received Quality, RSRQ, a duration and a location.

At step 710, the method may optionally comprise configuring a conditional event for the conditional handover process, the conditional event having a threshold related to a NES mode of a source cell.

At step 720, the method may further optionally comprise sending an indication, to the UE, the indication indicating that the UE may be handed over from a source cell to the candidate target cell according to the conditional handover process. The indication may thus be a condition for handover according to the conditional handover process.

Advantageously, the indication may be provided in a bitfield in a Downlink Control Information (DCI).

In some embodiments, the NES information may be transmitted to the UE in a Radio Resource Control (RRC) configuration message associated with the candidate target cell. For example, the NES information may be included in a CHO configuration for the conditional handover process. In particular, the NES information may be provided within IE CondTriggerConfig-r16.

The NES information may indicate that a cell is a NES cell.

Modifications, additions, or omissions may be made to method of FIG. 7. Additionally, one or more steps in the method of FIG. 7 may be performed in parallel or in any suitable order.

Advantageously, embodiments may enable UE mobility which accounts the NES type or mode of source or candidate target cells.

Some embodiments may be described by the following clauses:

### EMBODIMENTS

### Group A Embodiments

1. A method performed by a wireless device for network energy saving (NES)-related conditional handover in mobile communications, the method comprising:
   obtaining NES information for a conditional handover process, wherein the NES information indicates a candidate target cell for the conditional handover process.
2. The method of the previous embodiment, further comprising:
   scaling a threshold of a configured conditional event that triggers the conditional handover process based at least on the NES information.
3. The method of any one of the previous embodiments, wherein the NES information comprises at least one of:
   an offset in a reference signal received power (RSRP),
   an offset in a reference signal received quality (RSRQ),
   a duration,
   a location.
4. The method of any one of the previous embodiments, wherein:
   the NES information indicates that the candidate target cell is a NES cell; and
   the method further comprises scaling a threshold of a configured conditional event based at least on a predefined scaling information.
5. The method of any one of the previous embodiments, wherein:
   the NES information indicates that the candidate target cell is in an NES mode at a time of evaluating a conditional event that triggers the conditional handover process; and
   the method further comprises scaling a threshold of the conditional event based at least on a predefined scaling information.
6. The method of any one of the previous embodiments, wherein:
   a conditional event is used to trigger the conditional handover process;
   the conditional event is associated with a threshold related to an NES mode of either a source cell or the candidate target cell;
   the threshold indicates that the candidate target cell that is a NES cell is excluded from the conditional handover process if the source cell is not an NES cell.
7. The method of any one of the previous embodiments, wherein if the wireless device is an NES wireless device, the candidate target cell that is determined to be a NES cell is prioritized over other candidate target cells that are not NES cells.
8. The method of any one of the previous embodiments, wherein the NES information is provided by the candidate target cell during the conditional handover process.
9. The method of any one of the previous embodiments, wherein the NES information is provided from a serving cell.
10. The method of any one of the previous embodiments, wherein the NES information comprises an indication of whether the candidate target cell is a NES cell and/or an indication that a specific NES mode is applied at the candidate target cell.
11. The method of any one of the previous embodiments, wherein the NES information comprises an indication of whether each of a set of candidate target cells is a NES cell.
12. The method of any one of the previous embodiments, wherein the conditional handover process for the wireless device is triggered in response to determining that a buffer status reporting (BSR) associated with the wireless device is higher than a first threshold value.
13. The method of any one of the previous embodiments, wherein the conditional handover process for the wireless device is triggered in response to determining that a buffer status reporting (BSR) associated with the wireless device is less than a second threshold value.
14. The method of any one of the previous embodiments, wherein the conditional handover process for the wireless device is triggered if one or more NES modes are turned off in a source cell
15. The method of any one of the previous embodiments, wherein:
   the conditional handover process for the wireless device is triggered in response to an indication that the wireless device is to be handed over from a source cell to the candidate target cell; and
   the indication is provided in a bitfield in a system information block (SIB), downlink control information (DCI), or medium access control control element (MAC-CE).
   16. The method of the previous embodiments, wherein:
   the NES information further indicates information about a set of candidate target cells for the conditional handover process;
   the method further comprises:
   ranking the set of candidate target cells for which a conditional event to trigger the conditional handover has been fulfilled based at least on the NES information; and
   selecting a particular candidate target cell based on the ranking.
18. A method performed by a wireless device, the method comprising:
   any of the wireless device steps, features, or functions described above, either alone or in combination with other steps, features, or functions described above.
19. The method of the previous embodiments, further comprising one or more additional wireless device steps, features or functions described above.
20. The method of any of the previous embodiments, further comprising:
   providing user data; and
   forwarding the user data to a host computer via the transmission to the network node or base station.

### Group B Embodiments

21. A method performed by a network node for network energy saving (NES)-related conditional handover in mobile communications, the method comprising:
   providing NES information in a conditional handover process to a wireless device, wherein the NES information indicates a candidate target cell for the conditional handover process.
22. The method of the previous embodiment, wherein information about the candidate target cell is provided by a source cell from which the wireless device is to be handed over to the candidate target cell.
23. The method of any one of the previous embodiments, wherein information about the candidate target cell is provided by an external network node handing the conditional handover process from a source cell to the candidate target cell for the wireless device.
24. The method of any one of the previous embodiments, wherein the NES information is provided to the wireless device within a radio resource control (RRC) configuration message associated with the candidate target cell.
25. The method of embodiment 24, wherein the RRC configuration message comprises wireless device dedicated information and a system information.
26. A method performed by a base station, the method comprising:
   any of the network node steps, features, or functions described above with respect to the base station, either alone or in combination with other steps, features, or functions described above.
27. The method of the previous embodiments, further comprising one or more additional base station steps, features or functions described above.
28. The method of any of the previous embodiments, further comprising:
   providing user data; and
   forwarding the user data to a host via the transmission to the wireless device.

### Group C Embodiments

29. A user equipment for network energy savings (NES)-related conditional handover in mobile communications, comprising:
   processing circuitry configured to perform any of the steps of any of the Group A embodiments; and
   power supply circuitry configured to supply power to the processing circuitry.
30. A network node for network energy savings (NES)-related conditional handover in mobile communications, the network node comprising:
   processing circuitry configured to perform any of the steps of any of the Group B embodiments;
   power supply circuitry configured to supply power to the processing circuitry.
31. A user equipment (UE) for network energy savings (NES)-related conditional handover in mobile communications, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.

1.-26. (canceled)

27. A method performed by a User Equipment, UE, for Network Energy Saving, NES,-related Conditional Handover, CHO, in mobile communications, the method comprising:
receiving, from a source cell, NES information in a CHO configuration for a conditional handover process, wherein the CHO configuration indicates a candidate target cell for the conditional handover process.

28. The method according to claim 27, wherein a conditional event for the conditional handover process is configured, the conditional event having a threshold related to a NES mode of the source cell.

29. The method according to claim 28, further comprising evaluating the conditional event for the conditional handover process based on the threshold related to the NES mode of the source cell.

30. The method according to claim 27, further comprising receiving an indication that the UE may be handed over from the source cell to the candidate target cell according to the conditional handover process; and triggering the conditional handover process in response to the indication.

31. The method according to claim 30, wherein the indication is a condition for handover according to the conditional handover process.

32. The method according to claim 30, wherein the indication is received from the source cell.

33. The method according to claim 32, wherein the indication is included in a bitfield in a Downlink Control Information, DCI.

34. The method according to claim 27, wherein the NES information is included within IE CondTriggerConfig-r16.

35. The method according to claim 27, wherein the NES information indicates that a cell is a NES cell.

36. The method according to claim 27, wherein the source cell is a NES cell.

37. The method according to claim 27, further comprising performing the conditional handover process based on the CHO configuration.

38. A method, performed by a network node of a source cell, for Network Energy Saving, NES-related Conditional Handover, CHO, in mobile communications, the method comprising:
sending, to a User Equipment, UE, NES information in a CHO configuration for a conditional handover process, wherein the CHO configuration indicates a candidate target cell for the conditional handover process.

39. The method according to claim 38, comprising configuring a conditional event for the conditional handover process, the conditional event having a threshold related to a NES mode of the source cell.

40. The method according to claim 38, further comprising sending an indication, to the UE, indicating that the UE may be handed over from the source cell to the candidate target cell according to the conditional handover process.

41. The method according to claim 40, wherein the indication is a condition for handover according to the conditional handover process.

42. The method according to claim 40, wherein the indication is provided in a bitfield in a Downlink Control Information, DCI.

43. The method according to claim 38, wherein the NES information is provided within IE CondTriggerConfig-r16.

44. The method according to claim 38, wherein the NES information indicates that a cell is a NES cell.

45. The method according to claim 38, wherein the source cell is a NES cell.

46. A User Equipment, UE, comprising:
processing circuitry configured to perform the method of claim 27; and
power supply circuitry configured to supply power to the processing circuitry.

47. A network node comprising:
processing circuitry configured to perform the method of claim 38; and
power supply circuitry configured to supply power to the processing circuitry.
